(19) United States
(12) Patent Application Publication
(10) Pub. No.: US 2025/0387784 A1
(43) Pub. Date: Dec. 25, 2025

(54) METHOD FOR REGENERATING A ZEOLITE-BASED HYDROCRACKING CATALYST, AND USE THEREOF IN A HYDROCRACKING PROCESS

(71) Applicant: IFP ENERGIES NOUVELLES, RUEIL-MALMAISON (FR)

(72) Inventors: Anne-Claire DUBREUIL, RUEIL-MALMAISON CEDEX (FR); Bertrand GUICHARD, RUEIL-MALMAISON CEDEX (FR)

(73) Assignee: IFP ENERGIES NOUVELLES, RUEIL-MALMAISON (FR)

(21) Appl. No.: 18/996,899

(22) PCT Filed: Jul. 4, 2023
(86) PCT No.: PCT/EP2023/068436

§ 371 Date: Jan. 17, 2025

(30) Foreign Application Priority Data
Jul. 22, 2022 (FR) FR2207546

(51) Int. Cl. B01J 38/16; B01J 29/14; B01J 35/61; B01J 35/63; C10G 47/20

(52) U.S. Cl. CPC B01J 38/16; B01J 29/146; B01J 35/617; B01J 35/633; B01J 35/635; C10G 47/20; B01J 2235/15; C10G 2300/1037; C10G 2300/703

(57) ABSTRACT

The present invention relates to a process for the regeneration of an at least partially spent catalyst resulting from a hydrocracking process, said at least partially spent catalyst resulting from a fresh catalyst comprising at least one metal from group VIII, at least one metal from group VIb and a support comprising at least one zeolite, said process comprising at least one regeneration stage in which the at least partially spent catalyst is subjected to a heat and/or hydrothermal treatment in the presence of an oxygen-containing gas at a temperature of between 350° C. and 460° C. so as to obtain a regenerated catalyst, said process not comprising a subsequent rejuvenation stage of bringing said regenerated catalyst into contact with at least one organic or inorganic and acidic or basic compound.

### TECHNICAL FIELD

The invention relates to a process for the regeneration of a hydrocracking catalyst without a stage of chemical modification and to the use of the regenerated catalyst in the field of hydrocracking. The present invention also relates to the regenerated catalyst obtained by the regeneration process according to the invention.

### PRIOR ART

The hydrocracking of heavy petroleum cuts is a key process in refining which makes it possible to produce, from surplus and not readily upgradable heavy feedstocks, lighter fractions, such as petrols, jet fuels and light gas oils, which the refiner is looking for in order to adjust his production to demand. Some hydrocracking processes make it possible to also obtain a highly purified residue which can constitute excellent bases for oils or a feedstock readily upgradeable in a catalytic cracking unit, for example. One of the effluents which is particularly targeted by the hydrocracking process is the middle distillate (fraction which contains the gas oil cut and the kerosene cut) but the gasoline produced can also be upgraded, in particular to feed routes for the production of petrochemical intermediates, according to whether a catalytic reforming or steam cracking installation is integrated into the complex. Another advantage of hydrocracking is that the use of strong hydrogenating functions makes it possible to obtain effluents, the qualities of which produced are very attractive as fuel bases. Mention will be made in particular of the cetane numbers of the gas oils obtained, which are among the best on the market, in particular because of the production conditions under which the process is carried out and which induces a very high degree of hydrogenation of aromatics. Mention may also be made of the viscosity index of the unconverted oil, which will be particularly advantageous for engine manufacturers.

Hydrocracking catalysts are generally classified on the basis of the nature of their acid function, in particular catalysts comprising an amorphous acid function of silica-alumina type and catalysts comprising a zeolitic cracking function, such as zeolite Y or zeolite beta, indeed even a mixture of several zeolites.

Hydrocracking catalysts are also classified according to the predominant product obtained during their use in a hydrocracking process, the two main products being middle distillates and naphtha. The term “naphtha cut” or “naphtha” is understood to mean the petroleum fraction having a lower boiling point than the middle distillates cut. The middle distillates cut generally exhibits cut points of between 150° C. and 370° C. in order to maximize the production of kerosene and of gas oil. Nevertheless, in the case of a process directed specifically at the production of naphtha, for example, the lower cut point of the middle distillates cut can be increased in order to increase the yields of naphtha. With this aim, the naphtha cut can exhibit boiling points between that of the hydrocarbon compounds having 6 carbon atoms per molecule (or boiling point of 68° C.) up to 216° C. and includes the gasoline cut. Similarly, the cut points of the middle distillates are capable of varying in order to increase the yields as long as the product remains within the specifications in force, which are themselves dependent on the geographical area of use.

It is known to use catalysts based on zeolite of FAU type to produce said light cuts, gasolines or middle distillates, which are more upgradable. These acidic solids are most often used shaped in an aluminum matrix which serves as binder. The catalyst, of bifunctional type, is then obtained after impregnation and activation of a metal phase on the preceding shaped support. In general, it is commonly accepted that these catalysts consist of a metal from group VIb chosen from molybdenum or tungsten and of a metal from group VIII chosen from cobalt or nickel.

This type of catalyst is not generally recycled in a short loop by the refiner and the catalyst is then discharged for separate recycling of the various constituents of the latter, with in particular metals recovered by metallurgical industries. Nevertheless, in some cases, it can be advantageous to carry out one or more stages of reprocessing of the catalyst with a view to its insertion in a new catalytic cycle of a hydrocracking unit. The existing prior art to do this includes the examples below.

The patent U.S. Pat. No. 9,266,099 (Cosmo Oil) describes a process for the regeneration of hydrocracking catalysts, the hydrocracking catalyst consisting of a zeolite providing the acid function and of a metal phase chosen from groups VIb and VIII and which carries the hydrogenating function. The spent catalysts resulting from the abovementioned process generally contain between 0.05% and 1% by weight of carbon and preferably consist of platinum and of zeolite USY with use in the hydrocracking of Fischer-Tropsch waxes. The regeneration process is based on a preliminary stage of washing the carbon-based feedstock residues present in the porosity before combustion of the coke under an oxidizing atmosphere at an intermediate temperature of between 250° C. and 400° C., before a stationary phase at a second, higher, temperature of between 350° C. and 550° C. The examples of this patent teach us that it would be preferable to regenerate at a higher temperature, that is to say 450° C. (example according to the invention) rather than 430° C. (comparative example), if the objective is to preserve a high activity and a high selectivity in hydrocracking.

The patent FR 2 771 950 (IFPEN) describes a process for the regeneration of an acidic solid comprising at least one refractory oxide and/or at least one molecular sieve, which has been used for the treatment of hydrocarbon feedstocks. To do this, the spent solid is treated at a temperature between 320° C. and 550° C. in the presence of a nitrogen oxide precursor chosen from nitrate or nitrite anions, nitryl, nitrosyl or NH₄⁺ cations, or organic compounds containing a nitro, nitroso, amino or ammonium function.

The patent FR 2 498 477 (IFPEN) describes a process for the regeneration of an acidic solid also consisting of at least one metal chosen from groups Ib, IIb or VIII. To do this, the spent solid is treated at a temperature between 300° C. and 600° C. before being treated at a lower temperature in the presence of 0.5% to 100% of steam, at less than 200° C.

In general, the above regeneration processes nevertheless do not make it possible to recover the performance qualities of the catalyst in the case of “bifunctional” hydrocracking solids and they are thus still of little applicability to industrialists, who prefer fresh catalysts to them.

In the case of hydrotreating catalysts, solutions have been found to overcome this problem. The addition of an organic compound to hydrotreating catalysts, that is to say without acid function, zeolite or silica-alumina in particular, is thus well exemplified in the literature. Their introduction makes it possible to improve their activity, for catalysts which have been prepared by impregnation followed by drying without subsequent calcination. These catalysts are often referred to as “additive-impregnated dried catalysts”. In order to overcome the shortfall in hydrodesulfurizing activity of the regenerated catalyst, a person skilled in the art can thus have recourse to an additional “rejuvenation” treatment. The rejuvenation process consists in reimpregnating the regenerated catalyst with a solution containing metal precursors in the presence or absence of organic or inorganic additives. These “rejuvenation” processes are well known to a person skilled in the art in the field of middle distillates. Many patents, such as, for example, U.S. Pat. Nos. 7,906,447, 8,722,558, 7,956,000, 7,820,579, FR 2 972 648, US2017/036202 or also CN102463127, thus provide different methods for carrying out the rejuvenation of the catalysts for the hydrotreating of middle distillates.

The document U.S. Pat. No. 7,956,000 in particular describes a rejuvenation process in which a catalyst comprising an oxide of a metal from group VIb and an oxide of a metal from group VIII is brought into contact with an acid and an organic additive, the boiling point of which is between 80° C. and 500° C. and a solubility in water of which is at least 5 grams per liter (20° C., atmospheric pressure), optionally followed by a drying operation under conditions such that at least 50% of the additive is maintained in the catalyst. The hydrotreating catalyst can be a fresh hydrotreating catalyst or a spent hydrotreating catalyst which has been regenerated.

The document US2014076780 describes the method of obtaining a catalyst comprising an amorphous support based on alumina, a di(C₁-C₄)alkyl succinate, citric acid and optionally acetic acid, phosphorus and a hydro-dehydrogenating function comprising at least one element from group VIII and at least one element from group VIb. The process for the preparation of said catalyst comprises the impregnation of a catalytic precursor, which can be in the dried, calcined or regenerated state, with an impregnation solution comprising at least a di(C₁-C₄)alkyl succinate and citric acid. The document teaches us that this rejuvenation treatment makes it possible in particular to remove the crystalline phases resistant to sulfiding which are generated during the high-temperature heat treatments.

Far fewer documents describe rejuvenation processes such as those proposed for the hydrotreating catalysts above, doubtless because of the complexity of implementation, on bifunctional catalysts for which the hydrogenating function, but also the acid function, have to be restored simultaneously. Some documents are, nevertheless, reproduced below.

The patent U.S. Pat. No. 5,206,194 (Union Oil Company) describes a process for the rejuvenation of hydrocracking catalysts consisting of an acid function chosen from a broad list of zeolites, including USY CBV720, CBV712 or LZ-210, and of a hydrogenating function provided by a metal from group VIII chosen from platinum or palladium. The spent catalyst consists of 2% to 20% of carbon and is regenerated before being reactivated. The catalyst regenerated between 510° C. and 680° C. contains less than 1% by weight of carbon and is rejuvenated with a solution consisting of ammonium salts, preferably chosen from ammonium nitrate, carbonate or bicarbonate. The hydrocracking catalyst obtained is employed under conditions such that the equivalent nitrogen content is less than 200 ppm. The examples of the document teach us quite clearly that a relatively high optimum regeneration temperature, between 540° C. and 590° C. (respectively between 1000° F. and 1100° F.), is necessary to maximize the converting activity, whether it concerns employment in the first hydrocracking stage or in the second stage, but in neither case does this temperature make it possible to achieve an activity comparable to that of the fresh catalyst. The rejuvenation stage makes it possible to improve the performance qualities but, as with a regeneration alone, the teachings lead us to target a high regeneration temperature.

The patent application US 20130137913 (Shell) describes a process for the rejuvenation of a zeolitic catalyst which is preferably used for the conversion of oxygen-based compounds into olefins of at least four carbon atoms. The acid function of the catalysts is provided by a 10-MR zeolite. The rejuvenation treatment consists in treating the catalyst with an acid solution consisting of acetic, oxalic or tartaric acid, or with an acidified aqueous ammonia solution consisting of various inorganic or organic acids chosen from HCl, HBr, HI, nitric acid, sulfuric acid, or para-toluenesulfonic acid. Moreover, the spent catalyst can be heat-treated beforehand in an oxidizing medium with, as desired, O₂, O₃, SO₃, N₂O, NO, NO₂ or N₂O₅ at a temperature of between 550° C. and 750° C., but the treatment can also take place before the stage of rejuvenation with the organic acid. The examples in this document teach us that a single regeneration results in a very sharp drop in activity and that the rejuvenation improves the performance qualities but does not make it possible to achieve conversions equivalent to those of the fresh catalyst.

The patent application US2018318822 (Exxon Mobil) describes a process for the regeneration and the rejuvenation of a spent catalyst. The spent catalyst is bifunctional in nature with a zeolite or a mixture of several zeolites and a metal phase composed of a metal from group VIb and of a metal from group VIII. This patent application targets a use in catalytic dewaxing. The spent catalyst is first regenerated under air at a temperature of between 370° C. and 710° C. in order to remove the coke and to obtain a calcined catalyst which is subsequently brought into contact with a solution containing a complexing agent, with a complexing agent molar ratio with respect to the metals of 1.25 to 10. Finally, the catalyst thus rejuvenated is dried only at low temperature. Citric acid is preferred and a glycol can also be used as complexing agent, and optionally both can be impregnated as a mixture. Once again, whatever the functions of the catalyst illustrated in the examples, the HDS, the HDN, the improvement in the cloud point, which are related to the isomerizing activity of the catalyst, the performance qualities of the regenerated catalyst at 540° C. are lower than those of the fresh catalyst and a regeneration results in an improvement, but which remains insufficient to return to the performance qualities of the fresh catalyst.

It thus appears that no sufficiently attractive technical solution exists to make possible the regeneration or the rejuvenation of a bifunctional hydrocracking catalyst consisting of a metal phase based on metals from group VIb and from group VIII and on an acid phase consisting of at least one zeolite. The examples of the literature generally report an insufficient catalytic activity or yield. Moreover, no information is provided on the hydrogenation performance qualities of the regenerated catalysts which would be obtained but, on the basis of the teachings established in the field of hydrotreating catalysts, it seems obvious that a significant deterioration in the product qualities, such as the cetane number of gas oil, would have to be endured if the hydrocracking catalyst is not rejuvenated after a regeneration stage alone.

The objective of the present invention is thus to provide a regeneration process which results at least in maintaining, indeed even improving, with respect to the corresponding fresh catalyst, the converting activities and/or the hydrogenating properties of hydrocracking catalysts based on metals from group VIII and from group VIb, and also on a zeolite, said catalysts having been deactivated beforehand during a working cycle in hydrocracking reactions. In particular, the invention is directed at the treatment of spent catalysts in processes for the hydrocracking of hydrocarbon feedstocks of any origin (fossil and/or vegetable and/or animal and/or resulting from plastic) exhibiting at least 2% by weight of coke and for which the loss in activity suffered is at least 7° C., with respect to the fresh catalyst, at a target conversion level defined beforehand by the refiner (and typically of between 60% and 90% conversion of the hydrocarbon feedstock to be treated).

This is because the applicant company has found that, surprisingly, contrary to the recurring teachings of the prior art, the implementation of a process for the regeneration of a spent hydrocracking catalyst comprising at least one metal from group VIII, at least one metal from group VIb and at least one acid function, at a sufficiently low temperature, that is to say of less than 460° C., makes it possible to obtain a hydrocracking catalyst with improved catalytic performance qualities compared to catalysts regenerated at higher temperatures, this being the case without having the need to resort to a rejuvenation treatment.

### SUMMARY OF THE INVENTION

The invention relates to a process for the regeneration of an at least partially spent catalyst resulting from a hydrocracking process, said at least partially spent catalyst resulting from a fresh catalyst comprising at least one metal from group VIII, at least one metal from group VIb and a support comprising at least one zeolite, said process comprising at least one regeneration stage in which the at least partially spent catalyst is subjected to a heat and/or hydrothermal treatment in the presence of an oxygen-containing gas at a temperature of between 350° C. and 460° C. so as to obtain a regenerated catalyst, said process not comprising a subsequent rejuvenation stage of bringing said regenerated catalyst into contact with at least one organic or inorganic and acidic or basic compound.

One advantage of the invention is to provide a regeneration process operating at low temperature which makes it possible to obtain a regenerated hydrocracking catalyst with improved catalytic performance qualities compared to the catalysts of the prior art regenerated at higher temperatures, and this being the case without having the need to resort to a rejuvenation treatment.

Another advantage of the invention is that of providing a process for the regeneration of a hydrocracking catalyst which makes it possible at least to maintain, with regard to the corresponding fresh catalyst, the converting activities and/or the hydrogenating properties of said catalyst.

The term “maintenance of the activity” is understood here to mean a difference in temperature to be applied in order to obtain a target conversion of a hydrocarbon feedstock, typically a vacuum distillate, which is a minimum, indeed even zero, compared to the fresh catalyst and a maximum compared to the spent catalyst. The term “maintenance of the HDN and HOA performance qualities and indirectly of the cetane number” is also understood to mean the fact of having available a regenerated catalyst which exhibits the performance qualities which are the closest possible to those of the fresh catalyst and thus the best possible compared to the spent catalyst.

Without being committed to any theory, it seems that, unlike the hydrotreating catalysts composed solely of amorphous oxides without a zeolitic acid function in their support, the hydrocracking catalysts form relatively little crystalline phase resistant to sulfiding, such as NiMoO₄, at low regeneration temperatures, which makes it possible to avoid resorting to an additional stage of treatment by rejuvenation with a chemical compound, whatever its nature, and thus simplifies the reprocessing of the spent catalyst.

Another advantage of the present invention is thus that of providing a regeneration process which is economically attractive and environmentally sustainable for industrialists. This result seems specific to the hydrocracking catalysts prepared based on non-noble metals, such as nickel, cobalt, molybdenum or tungsten.

The present invention also relates to the use of the regenerated catalyst prepared according to the process of the invention in a process for the hydrocracking of hydrocarbon cuts.

The present invention also relates to the regenerated catalyst obtained by the regeneration process according to the invention.

### Characterization Techniques

Subsequently, the groups of chemical elements are given according to the CAS classification (CRC Handbook of Chemistry and Physics, published by CRC Press, editor-in-chief D. R. Lide, 81st edition, 2000-2001). For example, group VIII according to the CAS classification corresponds to the metals of columns 8, 9 and 10 according to the new IUPAC classification.

The various atomic contents in the zeolites, the alumina precursors, the supports or the catalysts are measured by X-ray fluorescence, by atomic absorption spectrometry, by inductively coupled plasma (ICP) spectrometry or by combustion, using the method most suitable for the value measured.

The contents of metal from group VIb, of metal from group VIII and optionally of phosphorus in the fresh catalyst, in the at least partially spent catalyst or in the regenerated catalyst are expressed as oxides after correction for the loss on ignition of the catalyst sample. This correction makes it possible to compare the metal contents of the fresh, at least partially spent and regenerated catalysts. The loss on ignition of the catalyst corresponds to the sum of its contents of water, carbon, sulfur, nitrogen and/or any other contaminant which are removed by the heat treatment applied for the measurement of this loss on ignition. The latter is measured after a heat treatment in a muffle furnace at 550° C. for 1.5 hours.

Unlike the metal contents, the carbon or sulfur contents in the at least partially spent catalyst or in the regenerated catalyst are expressed with respect to the total weight of the catalyst under consideration, without correction of the loss on ignition.

The lattice constant a0 of the unit cell of the zeolite, or lattice parameter, is measured by X-ray diffraction (XRD) according to the standard ASTM 03942-80. X-ray diffraction is carried out with a PANalytical X'Pert Pro diffractometer operating in reflection and equipped with a rear monochromator using CuKalpha radiation (λK_{α1}=1.5406 Å, λK_{α2}=1.5444 Å).

According to the ICDD database, PDF sheet 00-012-0348, the NiMoO₄ crystalline phase exhibits several diffraction lines, the most intense line being located at d=3.35 Å. The lattice spacing d and the angular position q are linked by Bragg's law (with n the diffraction order=1 and l the wavelength of the X rays (1.5406 Å)): 2d sin(q)=nl

In the present description, the term “specific surface” or “BET surface” of the zeolites, of the supports or of the catalysts is understood to mean the BET specific surface determined by nitrogen adsorption in accordance with the standard ASTM D 3663-78 drawn up from the Brunauer-Emmett-Teller method described in the journal “The Journal of the American Chemical Society”, 60, 309 (1938). Four pressure points are used, p/p₀=0.050, 0.075, 0.100 and 0.125. Prior to the measurement of the nitrogen adsorption-desorption isotherm, the sample is pretreated at 450° C. for 4 hours under high vacuum (10⁻⁴ Pa).

The pore distribution measured by nitrogen adsorption was determined by the Barrett-Joyner-Halenda (BJH) model. The nitrogen adsorption-desorption isotherm according to the BJH model is described in the journal “The Journal of the American Chemical Society”, 73, 373 (1951), written by E. P. Barrett, L. G. Joyner and P. P. Halenda. The term “total pore volume” of the zeolites, of the supports or of the catalysts is understood to mean the volume measured by nitrogen adsorption for p/p₀=0.99, pressure for which it is accepted that the nitrogen has filled all the pores.

The term “mesopore volume” of the zeolites is understood to mean the difference between the total pore volume described above and the micropore volume. The micropore volume is also determined from the nitrogen adsorption-desorption isotherm, using the “t” method (Lippens-De Boer method, 1965), which corresponds to a transform of the nitrogen adsorption isotherm, as described in the work “Adsorption by Powders and Porous Solids. Principles, Methodology and Applications”, written by F. Rouquérol, J. Rouquérol and K. Sing, Academic Press, 1999. Eight pressure points are used, p/p₀=0.075, 0.100, 0.125, 0.150, 0.175, 0.200, 0.250 and 0.300.

In the continuation of the text, the expressions “of between . . . and . . . ” and “between . . . and . . . ” are equivalent and mean that the limiting values of the interval are included in the described range of values. If such were not the case and if the limiting values were not included in the range described, such a clarification will be introduced by the present invention.

Within the meaning of the present invention, the various ranges of parameters for a given stage, such as the pressure ranges and the temperature ranges, can be used alone or in combination. For example, within the meaning of the present invention, a preferred range of pressure values can be combined with a more preferred range of temperature values.

The term “hydrotreating” is understood to mean reactions encompassing in particular hydrodesulfurization (HDS), hydrodenitrogenation (HDN) and hydrogenation of aromatics (HOA).

Hydrocracking consists, on the contrary, of all the reactions which involve a reduction in the boiling point of the compounds present in the feedstock. In other words, conversion of the compounds having a boiling point greater than a target temperature into products having a boiling point lower than this same temperature is spoken of. The choice of the temperature depends on the process and on the feedstocks. For a process targeted at maximizing gasoline, generally conversion with respect to a temperature in the vicinity of 150° C. to 200° C. is spoken of, whereas, for a process targeted at maximizing middle distillates (gas oil and kerosene), the conversion will be defined with respect to a temperature of between 350° C. and 385° C. approximately.

The term “fraction X₊” is understood to mean the combined compounds having a boiling point greater than this temperature X. The expression “net conversion of the fraction X₊” is understood to mean the difference between the yield of cut (or fraction) with a boiling point lower than the temperature X and the yield of cut with a boiling point lower than the temperature X present in the test feedstock, with respect to the yield of a cut with the boiling point greater than the temperature X in the feedstock, all the above yields being by weight.

### DESCRIPTION OF THE INVENTION

In accordance with the invention, the invention relates to a process for the regeneration of an at least partially spent catalyst resulting from a hydrocracking process, said at least partially spent catalyst resulting from a fresh catalyst comprising at least one metal from group VIII, at least one metal from group VIb and a support comprising at least one zeolite, said process comprising at least one regeneration stage in which the at least partially spent catalyst is subjected to a heat and/or hydrothermal treatment in the presence of an oxygen-containing gas at a temperature of between 350° C. and 460° C. so as to obtain a regenerated catalyst, said process not comprising an additional rejuvenation stage of bringing said regenerated catalyst into contact with at least one organic or inorganic and acidic or basic compound.

The regenerated catalyst obtained by the process according to the invention results from an at least partially spent catalyst, itself resulting from a fresh catalyst, used in a process for the hydrocracking of hydrocarbon cuts for a certain period of time and which exhibits a significantly lower activity than the fresh catalyst, which necessitates its replacement.

The term “at least partially spent catalyst” is understood to mean a catalyst discharged from a hydrocracking process carried out under the conditions as described below and which has not undergone a heat treatment under a gas containing air or oxygen at a temperature of greater than 250° C. (also often known as regeneration stage). It may have undergone a deoiling or a washing stage.

Preferably, the term “at least partially spent catalyst” is understood to mean a catalyst used in a process for the hydrocracking of vacuum distillates exhibiting at least 2% by weight of coke and for which the loss in activity suffered is at least 7° C., preferably of between 7° C. and 60° C. and more preferably still of between 10° C. and 40° C., with respect to the fresh catalyst, at a target conversion level defined beforehand by the refiner (and typically of between 60% and 90% conversion of the hydrocarbon feedstock to be treated).

### Target Performance Qualities

The performance qualities of the regenerated hydrocracking catalyst which is obtained according to the invention can be compared according to the converting activity with respect to a defined cut point. For example, it is possible to evaluate, at a given temperature and at given operating conditions, the fraction of the hydrocarbon feedstock having a boiling point greater than a given temperature, 370° C. for “maxi-middle distillate” processes or 175° C. for “maxi-naphtha” processes, which is converted. Another means for evaluating the catalyst is to look at the yield of hydrocarbon cuts of interest under given conditions or for a given conversion, the latter being defined as above. The cuts for which it is sought to maximize the yield can be just as well heavy gasoline, kerosene or gas oil, according to the cut points which the refiner will desire. Finally, a last criterion for evaluation of the catalyst regenerated according to the process of the invention is its ability to carry out a hydrodenitrogenation of the hydrocarbon cut, i.e. a percentage of removal of organic nitrogen, or also its ability to hydrogenate aromatic compounds, or also its ability to obtain gasoline, kerosene, gas oil or also unconverted oil cuts having advantageous qualities, it being possible for these to be all those which the refiner seeks to maximize in its operation. Mention will be made, by way of example, of the cetane number of gas oil or the viscosity index of unconverted oil, but other properties of products can also be recovered by the application of the process forming the subject matter of the invention.

### Fresh Catalyst

The fresh catalyst used in a process for the hydrocracking of hydrocarbon cuts is known to a person skilled in the art. It comprises at least one metal from group VIII, at least one metal from group VIb and a support comprising at least one zeolite as described below.

The metal from group VIb present in the active phase of the fresh catalyst is preferentially chosen from molybdenum and tungsten. The metal from group VIII present in the active phase of the fresh catalyst is preferentially chosen from cobalt, nickel and the mixture of these two elements. The active phase of the fresh catalyst is preferably chosen from the group formed by the combination of the elements nickel-molybdenum, cobalt-molybdenum, nickel-tungsten, nickel-molybdenum-tungsten and nickel-cobalt-molybdenum and very preferably the active phase consists of nickel and molybdenum, nickel and tungsten or a nickel-molybdenum-tungsten combination.

The content of metal from group VIII in the fresh catalyst is less than 20% by weight, preferably of between 0.03% and 15% by weight, very preferably between 0.5% and 10% by weight and more preferably still between 1% and 8% by weight, expressed as oxide of metal from group VIII, with respect to the total weight of the fresh catalyst.

The content of metal from group VIb in the fresh catalyst is of between 1% and 50% by weight, preferably between 5% and 40% by weight and more preferably between 10% and 35% by weight, expressed as oxide of metal from group VIb, with respect to the total weight of the fresh catalyst.

The metal from group VIII to metal from group VIb molar ratio of the fresh catalyst is generally less than 1, preferably of between 0.01 and 0.75 and very preferably of between 0.10 and 0.60.

Optionally, the fresh catalyst can additionally exhibit a content of phosphorus generally of less than 15% by weight, preferably of between 0.1% and 10% by weight, very preferably of between 0.1% and 8% by weight and more preferably still of between 0.2% and 6% by weight of P₂O₅, with respect to the total weight of fresh catalyst.

Furthermore, in the case where the fresh catalyst comprises phosphorus, the phosphorus/(metal from group VIb) molar ratio is generally of between 0.02 and 1, preferably of between 0.04 and 0.8 and very preferably of between 0.1 and 0.75.

According to the invention, the support comprises at least one zeolite. Said zeolite is preferably chosen from the zeolites belonging to the FAU (including zeolites X, Y, USY and any other designation of zeolites Y having undergone a dealumination treatment), BEA, ISV, IWR, IWW, MEI, UWY, MEL, MTW, MTT, MRE, FER or MFI groups and preferably the zeolite is chosen from 10-MR or 12-MR zeolites or also preferably from zeolites of the FAU or BEA groups. Some examples of zeolites resulting from the preceding families, without them restricting the list of possible choices thereto, are mentioned below: ZSM-5 (MFI), ZSM-11 (MEL), ZSM-12 (MTW), ZSM-23 (MTT), ZSM-35 (FER), ZSM-48 (MRE), CP841E, CP814C, CP811C-300, HSZB25, HSZB30, HSZB150, HSZ931, HSZ940, HSZ980 (BEA), or Y82, Y84, CP300-56, CBV712, CBV720, CBV760, CBV780, CBV500, HSZ320, HSZ330, HSZ331, HSZ385, HSZ350, HSZ360, HSZ390, HSZ341, or HSZ371 (FAU, or USY).

Preferably, the support comprises a zeolite USY and/or a zeolite beta, alone or as a mixture, and preferably it comprises and preferably consists of a zeolite USY. All the methods of preparation of zeolites are capable of being applied in the production of the zeolites used in the preparation of the fresh catalyst.

The content by weight of zeolite in said support is of between 1% and 80% by weight, preferably between 2% and 70% by weight and very preferably between 3% and 60% by weight, with respect to the total weight of said support.

When the support comprises a mixture of a zeolite USY and of a zeolite beta, the ratio by weight of USY with respect to beta is of between 1 and 20, preferably between 1.5 and 18 and more preferably still between 2 and 15.

Preferably, when the support comprises a zeolite USY, the latter exhibits a lattice parameter of between 24.10 and 24.70 Å, preferably between 24.15 and 24.60 Å, more preferably still between 24.20 and 24.56 Å, an Si/Al molar ratio of between 2 and 300, preferably between 2.5 and 150, more preferably still between 2.5 and 100, a BET specific surface of greater than 500 m²/g, preferably of between 600 and 1100 m²/g, more preferably still between 750 and 1000 m²/g, a mesopore volume of between 0.05 and 0.9 ml/g, preferably between 0.08 and 0.7 ml/g and more preferably still between 0.1 and 0.6 ml/g.

Preferably, when the support contains a zeolite beta, the latter exhibits an Si/Al molar ratio of between 5 and 300, preferably between 6 and 200, more preferably still between 6 and 100, a BET specific surface of greater than 500 m²/g, preferably of between 550 and 900 m²/g, more preferably still between 550 and 800 m²/g, a mesopore volume of between 0.05 and 0.9 ml/g, preferably between 0.1 and 0.9 ml/g and more preferably still between 0.15 and 0.85 ml/g.

The support can also advantageously comprise at least one oxide binder and preferably a porous solid chosen from the group consisting of aluminas, silicas, silica-aluminas or also titanium, boron, zirconium or magnesium oxides, used alone or as a mixture with alumina or silica-alumina. Preferably, the binder is based on alumina or on silica or on silica-alumina.

When the oxide binder is based on alumina, it contains more than 50% by weight of alumina, with respect to the total weight of the support, and, in general, it contains only alumina or silica-alumina as defined below.

Preferably, the oxide binder comprises alumina. The alumina can advantageously be provided in all its forms known to a person skilled in the art. Preferably, the alumina is chosen from the group consisting of alpha, rho, chi, kappa, eta and gamma aluminas. Very preferably, the alumina is gamma alumina.

In another embodiment, the oxide binder is a silica-alumina containing at least 50% by weight of alumina, with respect to the total weight of said oxide binder. The silica content in the binder is less than 50% by weight, with respect to the total weight of the support, generally less than 45% by weight, preferably less than 40% by weight.

When the binder for said catalyst is based on silica, it contains more than 50% by weight of silica, with respect to the total weight of the binder, and, generally, it contains only silica.

Preferably, the support comprising at least one zeolite advantageously exhibits a total pore volume of between 0.15 and 1.2 cm³·g⁻¹, preferably between 0.18 and 1.1 cm³·g⁻¹ and very preferably between 0.2 and 1.0 cm³·g⁻¹.

The BET specific surface of the support comprising at least one zeolite is advantageously greater than 150 m²·g⁻¹, preferably of between 150 and 900 m²·g⁻¹, very preferably between 180 and 850 m²·g⁻¹ and more preferably still between 200 and 800 m²·g⁻¹.

The support is advantageously provided in the form of beads, extrudates, pellets or irregular and nonspherical agglomerates, the specific shape of which can result from a crushing stage.

The fresh catalyst can also additionally comprise at least one organic compound containing oxygen and/or nitrogen and/or sulfur before sulfiding. Such additives are known to a person skilled in the art. Generally, the organic compound is chosen from a compound comprising one or more chemical functions chosen from a carboxylic, alcohol, thiol, thioether, sulfone, sulfoxide, ether, aldehyde, ketone, ester, carbonate, amine, nitrile, imide, oxime, urea and amide function or also compounds including a furan ring or also sugars.

The content of organic compound(s) containing oxygen and/or nitrogen and/or sulfur on the fresh catalyst is of between 1% and 30% by weight, preferably between 1.5% and 25% by weight and more preferably between 2% and 20% by weight, with respect to the total weight of the fresh catalyst.

The preparation of the fresh catalyst is known to a person skilled in the art and generally comprises a stage of impregnation of the metals from group VIII and from group VIb and optionally of phosphorus and/or of the organic compound on the support comprising at least one zeolite, followed by a drying operation, then by an optional calcination making it possible to obtain the metals in their oxide forms. Before its use in a process for the hydrocracking of hydrocarbon cuts, the fresh catalyst is generally subjected to a sulfiding in order to obtain the metals in their sulfided or partially sulfided forms, as is described below.

According to an alternative form of the invention, when an organic compound is present, the fresh catalyst has not undergone calcination during its preparation, that is to say that the impregnated catalytic precursor has not been subjected to a stage of heat treatment at a temperature of greater than 200° C. under an inert atmosphere or under an oxygen-containing atmosphere, in the presence or absence of water.

According to another alternative form of the invention, the fresh catalyst has undergone a calcination stage during its preparation, that is to say that the impregnated catalytic precursor has been subjected to a stage of heat treatment at a temperature of between 200° C. and 1000° C. and preferably between 250° C. and 750° C., for a period of time typically of between 15 minutes and 10 hours, under an inert atmosphere or under an oxygen-containing atmosphere, in the presence or absence of water.

Spent catalyst During the process for the hydrocracking of hydrocarbon cuts, coke, sulfur and nitrogen as well as possibly other contaminants resulting from the feedstock, such as silicon, arsenic and metals, are formed and/or deposited on the catalyst and transform the fresh catalyst into an at least partially spent catalyst.

The term “at least partially spent catalyst” is understood to mean a catalyst discharged from a hydrocracking process carried out under the conditions as described below and which has not undergone a heat treatment under a gas containing air or oxygen at a temperature of greater than 250° C. (also often known as regeneration stage). It may have undergone a deoiling or a washing stage.

Preferably, the term “at least partially spent catalyst” is understood to mean a catalyst used in a process for the hydrocracking of vacuum distillates exhibiting at least 2% by weight of coke and for which the loss in activity suffered is at least 7° C., preferably of between 7° C. and 60° C., more preferably still between 10° C. and 40° C., with respect to the fresh catalyst, at a target conversion level defined beforehand by the refiner (and typically of between 60% and 90% conversion of the hydrocarbon feedstock to be treated).

The at least partially spent catalyst is composed of a support comprising at least one zeolite and of a hydrogenating phase formed of at least one metal from group VIb, of at least one metal from group VIII, as well as carbon, sulfur, nitrogen and possibly other contaminants resulting from the feedstock, such as arsenic and metals.

The contents of metals from group VIb and from group VIII and optionally of phosphorus in the at least partially spent catalyst are substantially identical to the contents in the fresh catalyst from which it results.

The term “substantially identical” is understood to mean that each of the metal elements mentioned is present in the same proportions as in the initial fresh catalyst to within 5% relative.

It should be noted that the term “coke” or “carbon” in the present patent application denotes a substance based on hydrocarbons which is deposited on the surface of the at least partially spent catalyst during its use, this substance having a highly cyclized and condensed structure.

The at least partially spent catalyst contains in particular carbon at a content generally of greater than 2% by weight, preferably of between 2.5% and 40% by weight, very preferably between 3% and 30% by weight and more preferably still between 3.5% and 25% by weight, with respect to the total weight of the at least partially spent catalyst.

### Regeneration

The process for the regeneration according to the invention of the at least partially spent catalyst comprises a stage of removal, at least partial, of the coke, of the sulfur and of the nitrogen at relatively low temperature. According to the invention, the at least partially spent catalyst is subjected to a heat and/or hydrothermal treatment in the presence of an oxygen-containing gas at a temperature of between 350° C. and 460° C., so as to obtain a regenerated catalyst.

Even if this is possible, the regeneration is preferably not carried out by keeping the charged catalyst in the hydrocracking reactor (in situ regeneration). Preferably, the at least partially spent catalyst is thus extracted from the reactor and treated in a regeneration plant in order to carry out the regeneration in said plant (ex situ regeneration).

The regeneration stage is preferably preceded by a deoiling stage. The deoiling stage preferably comprises bringing the at least partially spent catalyst into contact with a stream of inert gas (that is to say essentially devoid of oxygen), preferably in a nitrogen atmosphere or the like, at a temperature of between 200° C. and 400° C., preferably between 250° C. and 350° C. The inert gas flow rate in terms of flow rate per unit volume of the catalyst is of between 5 and 150 SI·l⁻¹·h⁻¹. The deoiling stage has a duration of preferably between 3 and 7 hours. It can advantageously be carried out in the hydrocracking unit but can also be carried out ex situ like the regeneration stage proper.

In one embodiment, the deoiling stage can be carried out by light hydrocarbons, by steam treatment or any other analogous process.

In a preferred embodiment, the deoiling stage is replaced by a stage of washing with a hydrocarbon feedstock lighter than that employed in the hydrocracking process, for example a gas oil or a solvent which is liquid at ambient temperature, preferably an aromatic compound, such as toluene or xylene. The washing is carried out at a temperature of less than 250° C. and can be carried out continuously according to a traversed bed arrangement, or at reflux.

The deoiling stage makes it possible to remove the soluble hydrocarbons which might prove to be dangerous in the regeneration stage because they present risks of flammability under an oxidizing atmosphere.

According to the invention, the regeneration stage consists of a heat and/or hydrothermal treatment in the presence of an oxygen-containing gas, according to any technique known to a person skilled in the art. This treatment can be carried out, for example, in a traversed bed, in a swept bed or in a static atmosphere. For example, the oven used can be a rotary oven or a vertical oven comprising radial traversed layers or also a band oven.

According to the invention, the regeneration of the at least partially spent catalyst is carried out at a temperature of between 350° C. and 460° C., preferably between 360° C. and 450° C., in a preferred way between 370° C. and 430° C. and more preferably still between 380° C. and 420° C. The duration of the regeneration is preferably greater than 1 hour, more preferably of between 1 and 100 hours, in a preferred way between 1.5 and 25 hours and particularly preferably between 2 and 10 hours. The oxygen content of said gas is less than that of air (20% v/v), preferably it is of between 2% and 20% v/v, more preferably between 5% and 20% v/v and more preferably still the gas used is air alone.

The water content of said gas is advantageously of between 0 and 1000 g of water per kg of dry air, preferably between 0 and 500 g of water per kg of dry air, in a preferred way between 0 and 250 g of water per kg of dry air and more preferably still between 0 and 100 g of water per kg of dry air.

Preferably, the regeneration stage is carried out in an oxygen-containing gas stream. The gas flow rate in terms of flow rate per unit volume of the at least partially spent catalyst is preferably of between 20 and 2000 SI·l⁻¹·h⁻¹, more preferably between 30 and 1000 SI·l⁻¹·h⁻¹ and particularly preferably between 40 and 500 SI·l⁻¹·h⁻¹.

In an alternative form of the regeneration process, one or more temperature stationary phases are carried out at temperatures which are lower than the maximum temperatures of the regeneration stage.

In a preferred alternative form, the oxygen content of said gas is gradually increased from a content of between 2% and 10% v/v to a maximum content of less than or equal to 20% v/v during at least one of the regeneration stationary phases carried out in a single step or by including stationary phases with intermediate proportions of oxygen; preferably, the oxygen content is gradually increased during the last regeneration stationary phase carried out between 350° C. and 460° C.

In the case where the at least partially spent catalyst is subjected to a hydrothermal treatment, the latter can be carried out instead of or in combination with a steam-free heat treatment.

In accordance with the invention, said process does not comprise a subsequent rejuvenation stage of bringing said regenerated catalyst into contact with at least one organic or inorganic and acidic or basic compound, said organic compound preferably being chosen from complexing and/or chelating and/or polar organic compounds.

The regenerated catalyst comprises a metal phase formed of at least one metal from group VIb and of at least one metal from group VIII and a support comprising at least one zeolite.

Following the regeneration, the hydrogenating function comprising the metals from group VIb and from group VIII of the regenerated catalyst is in a partially oxidized form. Advantageously, it contains less NiMoO₄ (from the area of the diffraction line located at the lattice spacing d=3.35 Å) than if the catalyst had been regenerated at a higher temperature, that is to say at a temperature strictly of greater than 460° C. Preferably, the catalyst contains no or only traces of crystalline phases, such as NiMoO₄.

The contents of metals from group VIb and from group VIII and optionally of phosphorus in the regenerated catalyst are substantially identical to the contents of the at least partially spent catalyst and to the contents of the fresh catalyst from which it results. To do this, the contents are expressed with respect to the weight of the catalyst after correction for the loss on ignition (as described in the “Characterization techniques” part). Once again, the term “substantially identical” is understood to mean that each of the metal elements mentioned is present in the same proportions to within about 5% relative as in the at least partially spent catalyst or in the fresh catalyst from which it is derived.

The regenerated catalyst is characterized by a BET specific surface of greater than 80%, preferably of greater than 85% and very preferably of greater than 90% of that of the corresponding fresh catalyst.

The total pore volume of the regenerated catalyst is generally greater than 80%, preferably greater than 85% and very preferably greater than 90% of that of the corresponding fresh catalyst.

The regenerated catalyst obtained in the regeneration stage contains residual carbon at a content of less than 2% by weight, preferably of less than 1.5% by weight, particularly preferably of less than 1% by weight and very preferably of between 0.01% and 0.8% by weight, with respect to the total weight of the regenerated catalyst. The regenerated catalyst may also not contain residual carbon.

The regenerated catalyst can contain residual sulfur at a content of less than 3% by weight, preferably of less than 2% by weight, in a preferred way of between 0.01% and 1.5% by weight and more preferentially still between 0.1% and 1.2% by weight, with respect to the total weight of the regenerated catalyst. The regenerated catalyst may also not contain residual sulfur.

Optionally, the regenerated catalyst can additionally exhibit a low content of contaminants resulting from the feedstock treated by the fresh catalyst from which it results, such as arsenic, mercury, and metals such as nickel, vanadium, iron, calcium or sodium.

Preferably, the arsenic or mercury content is less than 2000 ppm by weight and very preferably less than 1000 ppm by weight, with respect to the total weight of the regenerated catalyst.

Preferably, the content for each metal which would not be present in the initial formulation of the fresh catalyst is less than 1% by weight and very preferably less than 5000 ppm by weight, with respect to the total weight of the regenerated catalyst.

Another subject matter of the invention concerns the catalyst obtained by the regeneration process according to the invention.

### Sulfidation (Optional Stage)

Before its use in a hydrocracking process, it is advantageous to transform the regenerated catalyst obtained according to the process according to the invention into a sulfided catalyst in order to obtain the metals in their sulfided or partially sulfided forms. This activation or sulfiding stage is carried out by methods well known to a person skilled in the art, and advantageously under a sulfo-reductive atmosphere in the presence of hydrogen and of hydrogen sulfide.

Said regenerated catalyst is advantageously sulfided ex situ or in situ. The sulfiding agents are H₂S gas, elemental sulfur, CS₂, mercaptans, sulfides and/or polysulfides, hydrocarbon cuts having a boiling point of less than 400° C. containing sulfur-based compounds or any other sulfur-containing compound used for the activation of hydrocarbon feedstocks with a view to sulfiding the catalyst. Said sulfur-containing compounds are advantageously chosen from alkyl disulfides, such as, for example, dimethyl disulfide (DMDS), alkyl sulfides, such as, for example, dimethyl sulfide, thiols, such as, for example, n-butyl mercaptan (or 1-butanethiol), and polysulfide compounds of tert-nonyl polysulfide type. The catalyst can also be sulfided by the sulfur contained in the feedstock to be desulfurized. Preferably, the catalyst is sulfided in situ in the presence of a sulfiding agent and of a hydrocarbon feedstock. Very preferably, the catalyst is sulfided in situ in the presence of a hydrocarbon feedstock additivated with dimethyl disulfide.

### Hydrocracking Process

Finally, another subject matter of the invention is the use of the catalyst regenerated according to the process of the invention in processes for the hydrocracking of hydrocarbon cuts.

The process for the hydrocracking of hydrocarbon cuts can be carried out in one or more reactors in series of the fixed bed type with recycle in the various hydrotreating and/or hydrocracking sections of which it is composed. These schemes are well known to the refiner and can be modulated as a function of the requirements in terms of selectivities or in terms of activity and yields. Mention will be made in particular of two-stage processes with recycling to the second reactor, one-stage processes without recycling, one-stage processes with recycling to the hydrotreating reactor or also recycling to the hydrocracking reactor. All the alternative forms known to a person skilled in the art can be applied to the use of the catalyst according to the invention. In other words, if the refiner integrates other stages, such as, for example, a hydrotreating, upstream or downstream of the hydrocracking, this remains within the field of use which can be envisaged according to the invention.

The process for the hydrocracking of hydrocarbon cuts is carried out in the presence of a catalyst regenerated according to the process according to the invention in at least one of the reactors of which it is composed. It can also be carried out in the presence of a mixture of a regenerated catalyst and of a fresh catalyst or of a catalyst of any other origin.

The metal phase, the acid phase and the support of the fresh catalyst may or may not be identical to those present in the regenerated catalyst. In particular, in the case where the performance qualities of the regenerated catalyst are not fully identical to those displayed by the corresponding fresh catalyst, the refiner may decide to string together one or more other fresh catalysts exhibiting different catalytic performance qualities so that the sequence meets the requirements of the process. The catalytic performance qualities, thus adjusted, can be the activity, the yield or the selectivity in the hydrocarbon products of interest or also the HDN, the hydrogenation of aromatics or the finer properties of products, such as the cetane number of gas oil or the viscosity index of unconverted oil, without these target properties alone constituting a limitation to the subject matter of the present invention.

In these hydrocracking processes, the operating conditions are those described below. They can vary in the case where several hydrocracking reactors would make up the process according to the rules of implementation well known to a person skilled in the art.

Advantageously, the catalyst according to the invention is used in the hydrocracking process according to the invention after a “pretreatment” section containing one or more hydrotreating catalyst(s) which can be any catalyst known to a person skilled in the art and which makes it possible to reduce the content of certain contaminants of the feedstock, such as nitrogen, sulfur or metals. The operating conditions (hourly space velocity, temperature, pressure, hydrogen flow rate, hydrocarbons flow rate, reaction configuration, and the like) of this “pretreatment” section can be diverse and varied in agreement with the knowledge of a person skilled in the art.

### Feedstocks

Highly varied feedstocks can be treated by the hydrocracking processes according to the invention. The feedstock employed in the hydrocracking process according to the invention is preferably a hydrocarbon feedstock, at least 5% by weight of the compounds of which exhibit an initial boiling point of greater than 300° C. and a final boiling point of less than 650° C., preferably at least 30% by weight, in a preferred way at least 50% by weight and more preferably at least 75% by weight of the compounds of which exhibit an initial boiling point of greater than 300° C. and a final boiling point of less than 650° C.

The feedstock is advantageously chosen from LCOs (Light Cycle Oil, light gas oils resulting from a catalytic cracking unit), atmospheric distillates, vacuum distillates, such as, for example, gas oils resulting from the direct distillation of crude oil or from conversion units, such as fluidized-bed catalytic cracking (or FCC for Fluid Catalytic Cracking), coking or visbreaking, feedstocks originating from units for the extraction of aromatics from lubricating oil bases or resulting from the solvent dewaxing of lubricating oil bases, distillates originating from processes for the fixed bed or ebullated bed desulfurization or hydroconversion of ATR (atmospheric residues) and/or of VR (vacuum residues) and/or of deasphalted oils, and deasphalted oils, paraffins resulting from the Fischer-Tropsch process, taken alone or as a mixture. Mention may be made of feedstocks of renewable origin (such as vegetable oils, animal fats, oil from the hydrothermal conversion or pyrolysis of lignocellulosic biomass) and also plastic pyrolysis oils. The above list is not limiting. Said feedstocks preferably have a T5 boiling point of greater than 300° C., in a preferred way of greater than 340° C., that is to say that 95% of the compounds present in the feedstock have a boiling point of greater than 300° C. and in a preferred way of greater than 340° C.

The nitrogen content of the feedstocks treated in the processes according to the invention is advantageously greater than or equal to 500 ppm by weight, preferably of between 500 and 10 000 ppm by weight, more preferably between 700 and 4000 ppm by weight and more preferably still between 1000 and 4000 ppm by weight. The sulfur content of the feedstocks treated in the processes according to the invention is advantageously of between 0.01% and 5% by weight, preferably between 0.2% and 4% by weight and more preferably still between 0.5% and 3% by weight.

The feedstock can optionally contain metals. The cumulative content of nickel and vanadium in the feedstocks treated in the processes according to the invention is preferably less than 1 ppm by weight.

The feedstock can optionally contain asphaltenes. The asphaltenes content is generally less than 3000 ppm by weight, preferably less than 1000 ppm by weight and more preferably still less than 200 ppm by weight.

Advantageously, when the catalyst obtained according to the process according to the invention is employed after a hydrotreating section as described above, the contents of nitrogen, sulfur, metals or asphaltenes in the liquid injected into the process according to the invention employing the catalyst obtained according to the process according to the invention are reduced. Preferably, the content of organic nitrogen of the feedstock treated in the hydrocracking process according to the invention is then, after hydrotreating, of between 0 and 200 ppm, preferably between 0 and 50 ppm and more preferably still between 0 and 30 ppm. The sulfur content is preferably less than 1000 ppm and the asphaltene content is preferably less than 200 ppm, while the content of metals (Ni or V) is less than 1 ppm.

The hydrocracking process according to the invention can comprise a fractionation stage between the pretreatment of the feedstock and the hydrocracking reactor(s) employing the catalyst according to the invention. In the preferred case where the hydrocracking process is carried out without (gas and liquid) fractionation between the pretreatment and the hydrocracking reactor(s) employing the catalyst obtained according to the process according to the invention, the nitrogen and the sulfur removed from the liquid after the pretreatment are injected in the form of NH₃ and of H₂S into the reactor(s) containing the catalyst according to the invention.

### Operating Conditions of the Hydrocracking Process

Preferably, the process for the hydrocracking of said hydrocarbon feedstock is implemented at a temperature of between 200° C. and 480° C., at a total pressure of between 1 MPa and 25 MPa, with a ratio of volume of hydrogen per volume of hydrocarbon feedstock of between 80 and 5000 I/I and at an hourly space velocity (HSV), defined by the ratio of the flow rate by volume of hydrocarbon feedstock per volume of catalyst charged to the reactor, of between 0.1 and 50 h¹.

Preferably, the hydrocracking process is carried out in the presence of hydrogen, at a temperature of between 250° C. and 480° C., preferably between 320° C. and 450° C., very preferably between 330° C. and 435° C., under a pressure of between 2 and 25 MPa, preferably between 3 and 20 MPa, at a space velocity of between 0.1 and 20 h¹, preferably between 0.1 and 6 h¹, in a preferred way between 0.2 and 3 h¹, and the amount of hydrogen introduced is such that the ratio of volume of hydrogen per volume of hydrocarbon feedstock is of between 100 and 2000 l/l.

These operating conditions used in the hydrocracking processes according to the invention generally make it possible to achieve conversions per pass, to give products having boiling points of less than 340° C. and preferably of less than 370° C., of greater than 15% by weight and more preferably of between 20% and 100% by weight.

### LIST OF THE FIGURES

FIG. 1 shows the XRD diffractograms of the catalysts S1, R1 and R2 over the range of lattice spacings of between 3.1 and 3.5 Å.

FIG. 2 shows the XRD diffractograms of the catalysts S2, R3 and R4 over the same range of lattice spacings. For better readability, the diffractograms are offset relative to one another along the y-axis.

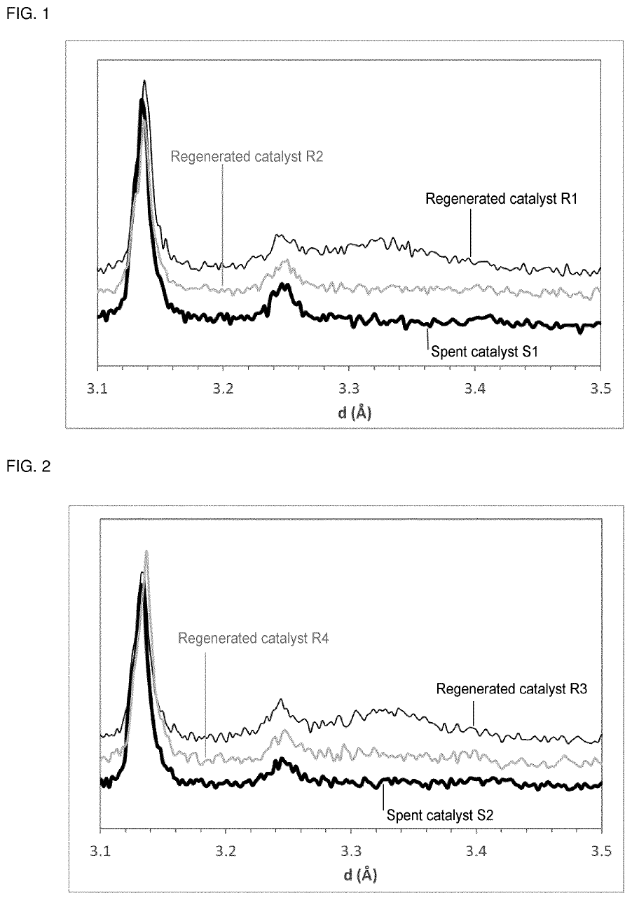

The diffraction line located at the lattice spacing d=3.35 Å is the most intense diffraction line of the NiMoO₄ crystalline phase. It is not present on the catalysts S1 and R2 (FIG. 1), nor on the catalysts S2 and R4 (FIG. 2). On the other hand, it is clearly visible on the catalysts R1 and R3.

The other diffraction lines correspond to zeolite USY (d=3.24 Å) and to the internal standard (certified silicon) added to the samples (d=3.14 Å).

### EXAMPLES

### Example 1: Obtaining the Spent Catalyst S1

A hydrocracking catalyst A was used for 2 years on a pilot hydrocracking unit operated as an industrial unit for vacuum distillates or VGO (Vacuum Gas Oil). The catalyst A contains 16% by weight of MoO₃, 3.5% by weight of NiO and 3.0% by weight of P₂O₅, which are deposited on a support consisting of 80% by weight of gamma alumina and of 20% by weight of zeolite USY having a lattice parameter of 24.28 Å. The catalyst A exhibits a BET specific surface of 385 m²/g and a pore volume of 0.60 ml/g.

The hydrocracking unit in which the catalyst A was implemented exhibits a two-reactor design, a first reactor intended for the hydrotreating of the feedstock and a second reactor intended for the hydrocracking proper. A hydrotreating catalyst of NiMo/alumina type was charged to the hydrotreating reactor. The catalyst A was charged to the second reactor intended for the hydrocracking. The feedstock employed was of VGO type with a mean T50 (analyzed by DS) in the vicinity of 430° C., and a nitrogen content of 1400 ppm.

Prior to the injection of the feedstock, the two catalysts were sulfided using a straight run gas oil, that is to say a gas oil resulting from the direct distillation of oil, additivated with 4% by weight of dimethyl disulfide (DMDS) and 2% by weight of aniline. The sulfiding is carried out at an HSV of 2 h⁻¹ (HSV=Hourly Space Velocity), an H₂/feedstock ratio by volume of 1000 SI/l, a total pressure of 14 MPa and a temperature of 350° C. for 6 hours.

After sulfiding, the temperature of the 1^{st} reactor was adjusted so as to target a nitrogen content at the outlet of this reactor of between 5 and 15 ppm throughout the cycle and the temperature of the 2^{nd} reactor was adjusted so as to target a net conversion of the 370° C.+ fraction of the order of 70%; in practice, this temperature varied from 376° C. to 400° C. When the temperature of 400° C. was no longer sufficient to maintain the 70% conversion, the cycle was interrupted. On average, the catalyst thus underwent a deactivation of 1° C./month.

After discharging from the hydrocracking reactor and after a deoiling stage carried out ex situ (washing with toluene at 250° C. under reflux), the catalyst was dried under low vacuum and then analyzed. The spent catalyst S1 is obtained; it contains 6% by weight of carbon.

### Example 2: Obtaining the Regenerated Catalyst R1 (Comparative)

A part of the spent catalyst S1 is subjected to regeneration under an oxidizing atmosphere at 480° C. for 2 hours under a water-free air flow of 450 SI/l/h. The regenerated catalyst R1, which contains 0.25% by weight of sulfur and no longer contains carbon, is obtained. Its metal composition is not modified in comparison with the new catalyst A. The XRD analysis demonstrates the presence of a NiMoO₄ phase, which was not present on the spent catalyst S1, as illustrated in FIG. 1. The catalyst R1 has a BET specific surface of 343 m²/g, which represents 89% of the BET specific surface of the new catalyst A. It also exhibits a pore volume of 0.57 ml/g, which represents 95% of the pore volume of the new catalyst A.

### Example 3: Obtaining the Regenerated Catalyst R2 (According to the Invention)

Another part of the spent catalyst S1 is subjected to regeneration under an oxidizing atmosphere at 400° C. for 2 hours under a water-free air flow of 450 SI/l/h. The regenerated catalyst R2, which contains 0.32% by weight of carbon and 1.1% by weight of sulfur, is obtained. Its metal composition is not modified compared to the new catalyst A. No NiMoO₄ phase is detectable by the XRD analysis, as illustrated in FIG. 1.

The catalyst R2 has a BET specific surface of 362 m²/g and a pore volume of 0.57 ml/g, which respectively represent 94% of the BET specific surface and 95% of the pore volume of the new catalyst A.

### Example 4: Obtaining the Spent Catalyst S2

The catalyst A described in example 1 was also used in the same hydrocracking unit as that used in example 1 but under temperature conditions making it possible to achieve and maintain throughout the test a net conversion of the 370° C.+ fraction of 85%. The initial temperature was set at 383° C. and was gradually increased over time to maintain the level of conversion indicated. After 2.5 years, and while the temperature to be applied was 418° C., the unit was shut down and the hydrocracking catalyst was discharged. The latter thus underwent a mean deactivation of approximately 1.2° C./month.

After a deoiling stage, as described in example 1, the spent catalyst S2 was obtained; it contains 12% by weight of carbon.

### Example 5: Obtaining the Regenerated Catalyst R3 (Comparative)

A part of the spent catalyst S2 undergoes regeneration under an oxidizing atmosphere at 480° C. for 2 hours under a water-free air flow of 450 SI/l/h. The regenerated catalyst R3, which contains 0.14% by weight of sulfur and no longer contains carbon, is obtained. Its metal composition is not modified in comparison with the new catalyst A. The XRD analysis demonstrates the presence of a NiMoO₄ phase, which was not present on the spent catalyst S2, as illustrated in FIG. 2.

The catalyst R3 has a BET specific surface of 347 m²/g, which represents 90% of the BET specific surface of the new catalyst A. It also exhibits a pore volume of 0.58 ml/g, which represents 96% of the pore volume of the new catalyst A.

### Example 6: Obtaining the Regenerated Catalyst R4 (According to the Invention)

Another part of the spent catalyst S2 undergoes regeneration under an oxidizing atmosphere at 400° C. for 2 hours under a water-free air flow of 450 SI/l/h. The regenerated catalyst R4, which contains 0.56% by weight of carbon and 0.39% by weight of sulfur, is obtained. Its metal composition is not modified compared to the new catalyst A. No NiMoO₄ phase is detectable by the XRD analysis, as illustrated in FIG. 2.

The catalyst R4 has a BET specific surface of 370 m²/g and a pore volume of 0.58 ml/g, which respectively represent 96% of the BET specific surface and 96% of the pore volume of the new catalyst A.

### Example 7: Catalytic Performance Qualities of the Catalysts A, S1, R1, R2, S2, R3 and R4

The performance qualities of the catalysts described above are evaluated in one-stage hydrocracking of a feedstock comprising a vacuum distillates fraction using an isothermal test pilot unit in downflow configuration.

This test feedstock was hydrotreated beforehand. After this hydrotreating stage, the test feedstock exhibits the properties of table 1 below. In order to simulate the hydrogen sulfide and ammonia partial pressures generated by the hydrotreating stage of the process, DMDS and aniline is respectively added to the test feedstock so as to obtain 15 300 ppm by weight of sulfur and 1400 ppm by weight of nitrogen in the final additivated feedstock.

### Characteristics of the Hydrotreated Feedstock

TABLE 1

| Characteristics | Unit | Value |
|---|---|---|
| Density at 15° C. | g/ml | 0.8889 |
| Nitrogen | ppm by | 46 |
| | weight | |
| Sulfur | ppm by | 143 |
| | weight | |
| Aromatic Carbon | % by weight | 9.4 |
| Initial distillation point, simulated | ° C. | 174 |
| (ASTM 6352) | | |
| T° C. 10% Distillation, simulated | ° C. | 343 |
| T° C. 20% Distillation, simulated | ° C. | 381 |
| T° C. 30% Distillation, simulated | ° C. | 404 |
| T° C. 40% Distillation, simulated | ° C. | 422 |
| T° C. 50% Distillation, simulated | ° C. | 439 |
| T° C. 60% Distillation, simulated | ° C. | 455 |
| T° C. 70% Distillation, simulated | ° C. | 473 |
| T° C. 80% Distillation, simulated | ° C. | 494 |
| T° C. 90% Distillation, simulated | ° C. | 523 |
| Final distillation point, simulated | ° C. | 599 |

Each catalyst is evaluated separately and is sulfided prior to the hydrocracking test using a straight run gas oil additivated with 4% by weight of dimethyl disulfide (DMDS) and 2% by weight of aniline. The sulfiding is carried out at an HSV of 2 h⁻¹, an H₂/feedstock ratio by volume of 1000 SI/l, a total pressure of 14 MPa and a temperature of 350° C. for 6 hours.

After sulfiding, the operating conditions are adjusted to those used for the hydrocracking test: HSV of 1.5 h¹, H₂/feedstock ratio by volume of 1000 SI/l, total pressure of 14 MPa. The temperature of the reactors is adjusted so as to target a net conversion of the 375° C.+ fraction of 80% after 150 hours under feedstock.

The performance qualities of the catalysts are compared with that of the catalyst A taken as reference and are given in table 2. The relative activity in degrees Celsius (° C.) is obtained by difference in the temperatures which are necessary to achieve one and the same net conversion of 80% between the catalyst A and the catalyst to be evaluated. A positive value means that the catalyst to be evaluated has a greater activity than that of the catalyst A. The HDN is measured as the degree of conversion of the nitrogen present in the feedstock (at the same test temperature applied) without taking into account the aniline, according to the following calculation:

$$\% HDN = ( ppmN\_feedstock - ppmn\_effluent ) / ( ppmN\_feedstock )$$

The relative volume activity (RVA) is then calculated in the following way (assuming that the HDN is a first-order reaction):

$$RVA\_HDN = ln ( / ( 1 - \% HDN\_catalyst ) ) / ln ( 1 / ( 1 - \% HDN\_catalyst \_A ) ) \times 100$$

Comparison of the performance qualities of the catalysts A (fresh), S1 and S2 (spent catalysts), R1, R2, R3 and R4 (regenerated catalysts). The regeneration temperatures, the carbon contents and the possible presence of a NiMoO₄ phase, as described in examples 1 to 6, are mentioned in this table.

TABLE 2

| | | | | HCK - | |
|---|---|---|---|---|---|
| | T | C (% by | Presence | Relative | |
| | regeneration | weight) | of NiMoO₄ | activity (° C.) | HDN - RVA |
| Fresh catalyst A | — | — | No | Base | 100 |
| (example 1) | | | | | |
| Spent catalyst S1 | — | 6 | No | −24 | 60 |
| (example 1) | | | | | |
| Regenerated | 480° C. - 2 h | 0 | Yes | −5 | 70 |
| catalyst R1 | | | | | |
| (comparative | | | | | |
| example 2) | | | | | |
| Regenerated | 400° C. - 2 h | 0.32 | No | −1 | 94 |
| catalyst R2 | | | | | |
| (example 3 | | | | | |
| according to the | | | | | |
| invention) | | | | | |
| Spent catalyst S2 | — | 12 | No | −35 | 49 |
| (example 4) | | | | | |
| Regenerated | 480° C. - 2 h | 0 | Yes | −12 | 65 |
| catalyst R3 | | | | | |
| (comparative | | | | | |
| example 5) | | | | | |
| Regenerated | 400° C. - 2 h | 0.56 | No | −7 | 90 |
| catalyst R4 | | | | | |
| (example 6 | | | | | |
| according to the | | | | | |
| invention) | | | | | |

The catalytic performance qualities observed above demonstrate the advantage of regenerating the catalysts at a lower temperature (in this instance 40000) than the temperatures usually applied according to the teachings taken from the prior art (48000 for the counterexamples provided). This is because the target converting activity, at the same HSV, pressure and incoming feedstock, is obtained for temperatures lower respectively by 4° C. and 5° C. with respect to the temperatures of the comparative examples.

Moreover, at the same test temperature, it is also shown that the efficiency of the catalysts regenerated according to the invention (at 400° C.) is increased with 90-94% of the HDN activity of the fresh catalyst, whereas the catalysts regenerated at higher temperatures (480° C.) do not make it possible to obtain better than 65-70% of the HDN activity of the fresh catalyst.

The regeneration process according to the invention is thus attractive for refiners, who have the possibility of regenerating the catalysts with a lower energy expenditure (lower regeneration temperature) while obtaining catalysts which are more efficient, this being the case even though the regenerated catalyst might possibly contain residual coke (in this instance 0.32% or 0.56% by weight for the examples according to the invention). Without being able to connect these results to any one theory, the advantage of the invention might be linked to satisfactory specific surfaces and pore volumes being obtained without, however, generating excessively large amounts of crystalline phase resistant to sulfiding, such as, for example, NiMoO₄.

1. A process for the regeneration of an at least partially spent catalyst resulting from a hydrocracking process, the at least partially spent catalyst resulting from a fresh catalyst comprising at least one metal from group VIII, at least one metal from group VIb and a support comprising at least one zeolite, the process comprising:
at least one regeneration stage in which the at least partially spent catalyst is subjected to a heat and/or hydrothermal treatment in the presence of an oxygen-containing gas at a temperature of between 350° C. and 460° C. so as to obtain a regenerated catalyst, said process not comprising a subsequent rejuvenation stage of bringing said regenerated catalyst into contact with at least one organic or inorganic and acidic or basic compound.

2. The process as claimed in claim 1, wherein the content of metal from group VIII in the fresh catalyst is less than 20% by weight, preferably of between 0.03% and 15% by weight, very preferably between 0.5% and 10% by weight and more preferably still between 1% and 8% by weight expressed as oxide of metal from group VIII, with respect to the total weight of the fresh catalyst, and the content of metal from group VIb in the fresh catalyst is of between 1% and 50% by weight, preferably between 5% and 40% by weight and more preferably between 10% and 35% by weight, expressed as oxide of metal from group VIb, with respect to the total weight of the fresh catalyst.

3. The process as claimed in claim 1, wherein said zeolite is chosen from the zeolites belonging to the FAU, BEA, ISV, IWR, IWW, MEI, UWY, MEL, MTW, MTT, MRE, FER or MFI groups and preferably the zeolite is chosen from 10-MR or 12-MR zeolites or also preferably from zeolites of the FAU or BEA groups.

4. The process as claimed in claim 1, wherein the support of the fresh catalyst comprises a zeolite USY and/or a zeolite beta, alone or as a mixture, and preferably the support comprises a zeolite USY.

5. The process as claimed in claim 4, wherein when the support comprises a zeolite USY, the latter exhibits a lattice parameter of between 24.10 and 24.70 Å, more preferably between 24.15 and 24.60 Å, more preferably still between 24.20 and 24.56 Å, an Si/Al molar ratio of between 2 and 300, more preferably between 2.5 and 150, more preferably still between 2.5 and 100, a BET specific surface of greater than 500 m²/g, more preferably of between 600 and 1100 m²/g, more preferably still of between 750 and 1000 m²/g, and a mesopore volume of between 0.05 and 0.9 ml/g, more preferably between 0.08 and 0.7 ml/g and more preferably still between 0.1 and 0.6 ml/g.

6. The process as claimed in claim 1, wherein the oxygen content in the gas used in the regeneration stage is of between 2% and 20% v/v, more preferably of between 5% and 20% v/v, and more preferably still the gas used is air alone, the water content in the gas used in the regeneration stage is of between 0 and 1000 g of water per kg of dry air, preferably of between 0 and 500 g of water per kg of dry air, in a preferred way between 0 and 250 g of water per kg of dry air and more preferably still between 0 and 100 g of water per kg of dry air, and the duration of the regeneration stage is greater than 1 hour, more preferably of between 1 and 100 hours, preferably of between 1.5 and 25 hours and particularly preferably of between 2 and 10 hours.

7. The process as claimed in claim 1, wherein the stage of regeneration of the at least partially spent catalyst is carried out at a temperature of between 360° C. and 450° C., preferably of between 370° C. and 430° C. and more preferably still between 380° C. and 420° C.

8. The process as claimed in claim 1, wherein the regenerated catalyst contains residual carbon at a content of less than 2% by weight, preferably of less than 1.5% by weight, particularly preferably of less than 1% by weight and very preferably of between 0.01% and 0.8% by weight, with respect to the total weight of the regenerated catalyst.

9. The process as claimed in claim 1, wherein the regenerated catalyst does not contain residual carbon.

10. The process as claimed in one of the preeding, claim 1, wherein the regenerated catalyst contains residual sulfur at a content of less than 3% by weight, preferably of less than 2% by weight, in a preferred way of between 0.01% and 1.5% by weight and more preferentially still of between 0.1% and 1.2% by weight, with respect to the total weight of the regenerated catalyst.

11. A process for hydrocracking of hydrocarbon cuts comprising hydrocracking hydrocarbon cuts in the presence of a catalyst obtained according to the process of claim 1.

12. The process as claimed in claim 1, wherein the content of metal from group VIII in the fresh catalyst is between 0.03% and 15% by weight, expressed as oxide of metal from group VIII, with respect to the total weight of the fresh catalyst, and the content of metal from group VIb in the fresh catalyst is between 5% and 40% by weight, expressed as oxide of metal from group VIb, with respect to the total weight of the fresh catalyst.

13. The process as claimed in claim 1, wherein said zeolite is chosen from 10-MR or 12-MR zeolites.

14. The process as claimed in claim 1, wherein said zeolite is chosen from zeolites of the FAU or BEA groups.

15. The process as claimed in claim 1, wherein the support of the fresh catalyst comprises a zeolite USY.

16. The process as claimed in claim 15, wherein when the zeolite USY exhibits a lattice parameter of between 24.15 and 24.60 Å, an Si/Al molar ratio of between 2.5 and 150, a BET specific surface of between 600 and 1100 m²/g, and a mesopore volume of between 0.08 and 0.7 ml/g.

17. The process as claimed in claim 1, wherein the oxygen content in the gas used in the regeneration stage is between 5% and 20% v/v, the water content in the gas used in the regeneration stage is of between 0 and 500 g of water per kg of dry air, and the duration of the regeneration stage is between 1 and 100 hours.

18. The process as claimed in claim 1, wherein the stage of regeneration of the at least partially spent catalyst is carried out at a temperature of between 370° C. and 430° C.

19. The process as claimed in claim 1, wherein the regenerated catalyst contains residual carbon at a content of less than 1.5% by weight with respect to the total weight of the regenerated catalyst.

20. The process as claimed in claim 1, wherein the regenerated catalyst contains residual sulfur at a content of less than 2% by weight with respect to the total weight of the regenerated catalyst.
